(19) United States
(12) Patent Application Publication
(10) Pub. No.: US 2012/0123966 A1
(43) Pub. Date: May 17, 2012

(54) MULTIDIRECTIONAL DISTRIBUTED RECURSIVE PORTFOLIO ALLOCATION

(75) Inventors: Matthew Klein, RYE BROOK, NY (US); Matthew Vella, Valhalla, NY (US)

(73) Assignee: COLLECTIVE2 LLC, RYE BROOK, NY (US)

(21) Appl. No.: 13/293,663

(22) Filed: Nov. 10, 2011

Related U.S. Application Data
(60) Provisional application No. 61/414,620, filed on Nov. 17, 2010.

(51) Int. Cl. G06Q 40/06

(52) U.S. Cl. 705/36 R

(57) ABSTRACT

A system and method for sharing portfolio allocation information among various participants while dispensing with the notion of specific roles of advisors and followers. The system and method includes a mechanism for allowing any participant to follow any other participant while creating greater diversity. The system and method may also provide an advice-following mechanism where those people who make smart investment decisions, or those people who are good at picking other people to make smart investments, will garner more followers and/or rewards.

### CROSS-REFERENCE TO RELATED APPLICATIONS

This application claims priority to U.S. Provisional Patent Application No. 61/414,620, filed on Nov. 17, 2011, entitled “Multidirectional Distributed Recursive Portfolio Allocation,” by Matthew Klein, which is hereby incorporated by reference.

### FIELD OF THE INVENTION

The present disclosure relates generally to investment portfolio management and asset allocation, and more particularly, to a system, method, and software for dynamic allocation of assets among a plurality of investments and options where all participants may be simultaneously both advisors and followers.

### BACKGROUND OF THE INVENTION

In finance, an investment strategy is a set of rules, behaviors, or procedures designed to guide an investor's selection of an investment portfolio. Typically the strategy may be designed around an investor's risk-return tradeoff. Generally, some investors may prefer to maximize expected returns by investing in risky assets while others may prefer to minimize risk by investing in stable investment vehicles (e.g., bonds), but most investors tend to select a more balanced portfolio somewhere in between.

Investment strategies typically involve asset allocation, which is the distribution of investment assets among a variety of investment opportunities in order to provide a particular balance of risk and return. For example, equities (e.g., stocks, mutual funds, etc.) generally provide a higher potential return on investment than bonds, but at a higher risk for potential loss, while cash generally provides a fixed return on investment with no risks (e.g., money market).

Investors typically rely on the advice of others when choosing investments and/or allocations. Generally, these investments and/or allocations are hand-picked by a financial advisor/banker or chosen by a computer algorithm that uses investment statistics (e.g., stock and investment trends) to choose the appropriate investment for a particular individual. Typically, investments are customized for a particular investor based on his or her particular circumstances (e.g., age, assets, income, expenses, etc.). A system, method, and computer program product for cost-effective, dynamic allocation of assets among a plurality of investments is disclosed in U.S. Pat. No. 7,769,659 to Arena, et al., which is hereby incorporated by reference in its entirety. The Arena patent teaches a computer program that controls reallocation of assets to reduce the transaction costs associated with rebalancing the investor's composite assets according to a composite asset allocation model. In the Arena model, investments are chosen for the investor based upon stored information relating to the composite asset allocation model, the investor's assets, and the investor. As discussed by Arena, et al., evaluation of an investor's assets is generally a continuous process, but reallocation of resources is generally performed quarterly or whenever the degree of unbalance relative to the asset allocation model exceeds a given threshold.

Although useful, people are familiar with this well-known notion of investors following portfolio-allocation advice from expert trading advisors, and sometimes, as taught by Arena, et al., through the use of automated software. For example, there are numerous websites that allow an investor to build a trading portfolio by combining the advice of several trading advisors and then following the instructions of those advisors, at an investor-specified weighting, in a customer trading account.

Despite the numerous existing investment programs, the need exists for improved trading systems that eliminate defined roles between advisors and followers.

### SUMMARY OF THE INVENTION

Two different skill sets tend to play a significant role in the success or failure in the area of investing. The first skill is the ability to pick a smart investment, while the second skill is the ability to pick people (e.g., investors or bankers) who can pick smart investments. However, it should be recognized that these skills are not exclusive, and an individual may exhibit one or both skills simultaneously. By eliminating the defined roles between advisors and followers, investors are able to better diversify while being exposed to more options and potentially discovering particular investments that are the product of many investors working in concert (knowingly or unknowingly).

In a first aspect, the present invention is directed to a process for sharing portfolio allocation information among various users. The process comprises the steps of: maintaining first portfolio allocation information concerning a plurality of first portfolio allocations in a database on a first server connected over a network to a plurality of user processors, wherein each first portfolio allocation is associated with a respective first user account; sending said first portfolio allocation information to a second user processor over said network in response to an inquiry from said second user processor, wherein said first portfolio allocation information includes performance information concerning each of said plurality of first portfolio allocations; receiving second portfolio allocation information concerning a second portfolio allocation from said second user processor over said network, wherein said second portfolio allocation information is based, at least in part, on said one or more first portfolio allocations; and incorporating said second portfolio allocation into said plurality of first portfolio allocations.

In a second aspect, the invention is to a process for selecting portfolio allocation information from a shared portfolio allocation database. The process comprises the steps of: sending an inquiry from a second user processor over a network to a first server for first portfolio allocation information concerning a plurality of first portfolio allocations, wherein said first server comprises said shared portfolio allocation database, and wherein each first portfolio allocation is associated with a respective first user account; receiving first portfolio allocation information at said second user processor over said network from said first server in response to said inquiry, wherein said first portfolio allocation information includes performance information concerning each of said plurality of first portfolio allocations; establishing second portfolio allocation information concerning a second portfolio allocation at said second processor, wherein said second portfolio allocation information is based, at least in part, on said one or more first portfolio allocations; and sending said second portfolio allocation information from said second user processor over said network to said first server for incorporation into said plurality of first portfolio allocations.

In a third aspect, the present invention is directed to a computer system for sharing portfolio allocation information among various users. The computer system comprising: a memory device having a database stored thereon; a communication device operatively coupled to the memory device to receive input from a plurality of user processors over a network; and at least one processor, operatively coupled to the communications device; wherein the at least one processor maintains first portfolio allocation information concerning a plurality of first portfolio allocations in the database connected over said network to the plurality of user processors, wherein each first portfolio allocation is associated with a respective first user account; wherein the at least one processor sends said first portfolio allocation information to a second user processor over said network in response to an inquiry from said second user processor, wherein said first portfolio allocation information includes performance information concerning each of said plurality of first portfolio allocations; wherein the at least one processor receives second portfolio allocation information concerning a second portfolio allocation from said second user processor over said network, wherein said second portfolio allocation information is based, at least in part, on said one or more first portfolio allocations; and wherein the at least one processor incorporates said second portfolio allocation into said plurality of first portfolio allocations.

According to another aspect of the present invention, the second portfolio allocation information may be based on a fraction of an individual first portfolio allocation or based on multiple fractions, at least two of said multiple fractions being associated, respectively, with corresponding first portfolio allocations selected from the plurality of first portfolio allocations.

According to a further aspect of the present invention, each portfolio allocation in the plurality of first portfolio allocations may be hypothetical.

According to yet another aspect of the present invention, the first portfolio allocation information may be searchable and/or the second portfolio allocation may be selectable from individual securities, or percentages thereof, and/or from said one or more first portfolio allocations, or percentages thereof.

According to yet another aspect of the present invention, each of the plurality of first portfolio allocations may be based on one or more individual securities, or percentages thereof, and/or from one or more other first portfolio allocations, or percentages thereof.

According to yet another aspect of the present invention, each portfolio allocation may be assigned a ticker symbol.

### BRIEF DESCRIPTION OF THE DRAWINGS

These and other advantages of the present invention will be readily understood with reference to the following specification and attached drawings wherein:

FIG. 1 is a block diagram of a computer server equipped to operate MDRPA software;

FIG. 2 is a first example of investor allocations;

FIG. 3 is an example graph of investor allocation performance;

FIGS. 4a and 4b illustrate a second example of investor allocations;

FIGS. 5a and 5b illustrate a third example of investor allocations;

FIGS. 6a and 6b illustrate a fourth example of investor allocations;

FIG. 7a is an example algorithm of recursively reallocating the portfolio; and

FIG. 7b illustrates an example of investor allocations after recursively reallocating the portfolio.

### DETAILED DESCRIPTION OF THE INVENTION

Preferred embodiments of the present invention will be described hereinbelow with reference to the accompanying drawings. In the following description, well-known functions or constructions are not described in detail because they would obscure the invention in unnecessary detail. The present disclosure illustrates systems and methods for investing and allocating funds within a computer network (e.g., a networked software platform/server reachable through the Internet). Under various disclosed embodiments, a computer network is equipped with hardware and/or software to enable remote users (e.g., people using a computer connected to the Internet) to interface with a server equipped to run investment allocation software or methodology. In a preferred embodiment, the investment allocation software or methodology would be implemented via Multidirectional Distributed Recursive Portfolio Allocation (MDRPA) software, which is described in greater detail below. For this application the following terms and definitions shall apply:

The term “communicate” and “communicating” as used herein include both conveying data from a source to a destination and delivering data to a communications medium, system, channel, network, device, wire, cable, fiber, circuit, and/or link to be conveyed to a destination, and the term “communication” as used herein means data so conveyed or delivered. The term “communications” as used herein includes one or more of a communications medium, system, channel, network, device, wire, cable, fiber, circuit, and link.

The term “database” as used herein means an organized body of related data, regardless of the manner in which the data or the organized body thereof is represented. For example, the organized body of related data may be in the form of one or more of a table, a map, a grid, a packet, a datagram, a frame, a file, an e-mail, a message, a document, a report, a list, or in any other form.

The term “investment” as used herein means a commitment of money or capital, actual or hypothetical, to purchase financial instruments or other assets with the intent or hope of gaining profitable returns. The term “investment” as used herein includes, but is not limited to, Foreign and Domestic Stocks, Mutual Funds, Real Estate, U.S. Treasury Bonds, U.S. Treasury TIPS, or Commodities.

The term “network” as used herein includes both networks and inter-networks of all kinds, including the Internet, and is not limited to any particular network or inter-network.

The term “processor” as used herein means processing devices, apparatus, programs, circuits, components, systems, and subsystems, whether implemented in hardware, tangibly embodied software, or both, and whether or not programmable. The term “processor” as used herein includes, but is not limited to, one or more computers, hardwired circuits, signal modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing.

Multidirectional Distributed Recursive Portfolio Allocation (MDRPA) methodology and/or software allows multiple users (e.g., participants), including both experienced and inexperienced investors, to invest funds, track each other's performance, and adopt allocations of other participants (either fully or in part). The MDRPA software may be located on a publicly accessible server, where participants may gain access (e.g., join, create an account, or provide a user name and/or password) from a remote location (e.g., a computer, portable device, or other Internet-accessible device) allowing them to allocate funds in a portfolio.

Participants may be able to gain access to the MDRPA software without having to meet certain qualifications or prerequisites, therefore creating a larger, more diverse participant base. However, certain prerequisites (e.g., human verification, age verification, nominal fee, etc.) may be implemented in order to ensure quality and security and/or prevent spamming. In the following embodiments, a hypothetical sum of money, having no monetary value, may be provided to the participant to be allocated as desired in various investments in order to create a portfolio simulation. Although the funds provided in the present application are hypothetical, the following disclosure may be readily applied to situations where actual monetary investments are involved, such as those where real money, or other currency, is exchanged. As time progresses and participants allocate and/or re-allocate their portfolio funds, each participant's portfolio value may fluctuate. These fluctuations, changes, allocations and/or other decisions may be tracked by the MDRPA software and resulting data may be stored to a database. Accordingly, the following disclosure may be used to generate data related to stock and/or indices, which may be used as a basis for actual monetary investments.

Data pertaining to each participant's portfolio allocations and/or decisions may be available for public viewing, searching, and/or analysis (e.g., via a MDRPA website). However, this data may also be restricted to only fellow participants of the MDRPA software and/or website. In other words, to view the data, a person may be obligated to at least create an account with the MDRPA website. Restricting the data to fellow participants may be beneficial by encouraging people to participate in creating additional data and statistics rather than merely viewing, searching, and/or analyzing other people's existing data.

In certain embodiments, a participant may be compensated based on the global capitalization that is ultimately following that participant. In other words, those participants who make smart investment decisions, or those participants who are good at picking other participants who make smart investment decisions (based on portfolio value growth), will garner more followers and thus be rewarded. For example, if the MDRPA software determines that a certain number/percentage of participants is following the portfolio of a particular participant, that participant may be rewarded, either monetarily or in investment credit. This reward system may be beneficial because it may encourage participants to actively participate and compete to build more valuable portfolios.

In certain embodiments, the MDRPA website may opt to generate revenue from its participants. Revenue may be generated using conventional advertising techniques and/or charging a membership or enrollment fee. For example, it may cost around $X dollars (calculated based on average broker fees) each month to enable automated trading of a portfolio with a real broker, while the MDRPA software/website may charge only a percentage of that $X dollars. The revenues may be used to create a pool of money ($Y dollars) that may be distributed to the MDRPA participants in the form of rewards in order to incentivize participation by talented/successful investors.

As previously mentioned, the MDRPA reward distribution algorithm will be weighted so that participants who have the most followers will earn the most money. For example, on a periodic basis (e.g., monthly), the hypothetical market capitalization will be calculated (assuming each investor started with an equal amount of money) by combining the value of all of the user's portfolios. For each participant, the MDRPA reward distribution algorithm may determine, at that moment in time, what percent (F %) of the entire site's virtual capitalization is attributed to the following of that particular participant. As a result, that participant will receive F % of the total pool to be distributed ($Y).

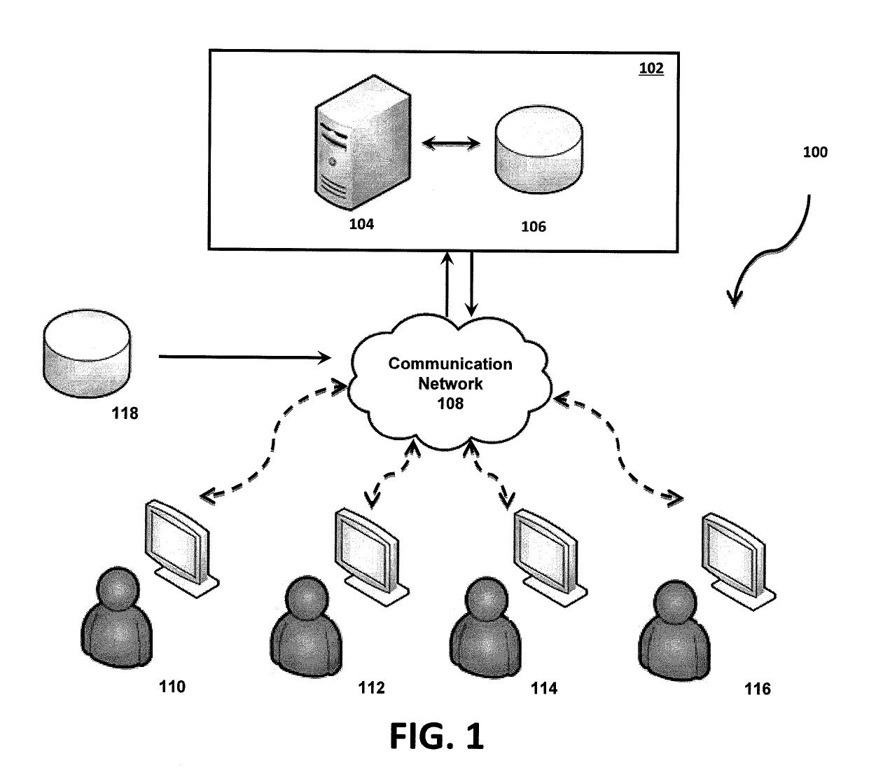

Referring now to FIG. 1, an example system 100 is shown wherein one or more participants 110, 112, 114, 116 may connect to a server system 102 using a communication network 108 (e.g., via a MDRPA website). The server system 102 could include a database 106 and processor 104 capable of running MDRPA software. The database 106 may be used to store the MDRPA source code and/or collected/gathered data related to participants 110, 112, 114, 116, investment allocations/portfolios, and other data generated or collected by the MDRPA software and/or MDRPA website. The server system 102 may also be in communication with a financial data source 118 that may be capable of providing real-time information for the investments. The financial data source 118 may be composed of one or more sources preferably having up-to-date and/or real-time information regarding investments (e.g., a financial institution, a periodical, a stock market, etc.).

When a participant first gains access to the MDRPA website, the participant (investor), is given or allocated a predetermined sum of money, or credit to invest (e.g., $100,000). As previously mentioned, the sum of money provided to the investor preferably does not have any monetary value, but rather, is used to create an investment simulation and to generate data and statistics. Nevertheless, the following disclosure may easily be applied to situations where real money or other currency is exchanged. Furthermore, the actual amount of the money or credit provided to the participant may be irrelevant because investment decisions and allocations are based on a percentage of the portfolio, and not a dollar value. Investors may allocate and customize their account portfolio by choosing from a plurality of investments (e.g., various stocks, bonds, funds, futures, commodities, etc.).

As investments are chosen and time elapses, each investor's portfolio value will fluctuate based on real market conditions and performance (e.g., if IBM stock increases 5% on Wall Street, the value of IBM in the MDRPA simulation will also increase 5%). As previously mentioned, monthly rewards may be distributed to investors on a pro-rated basis (e.g., based on what percentage of capitalization is devoted to “following” each person). Assuming each investor started with an equal amount of money, summing the value of all of the users' portfolios (at any given moment in time) will calculate the market capitalization of the MDRPA website.

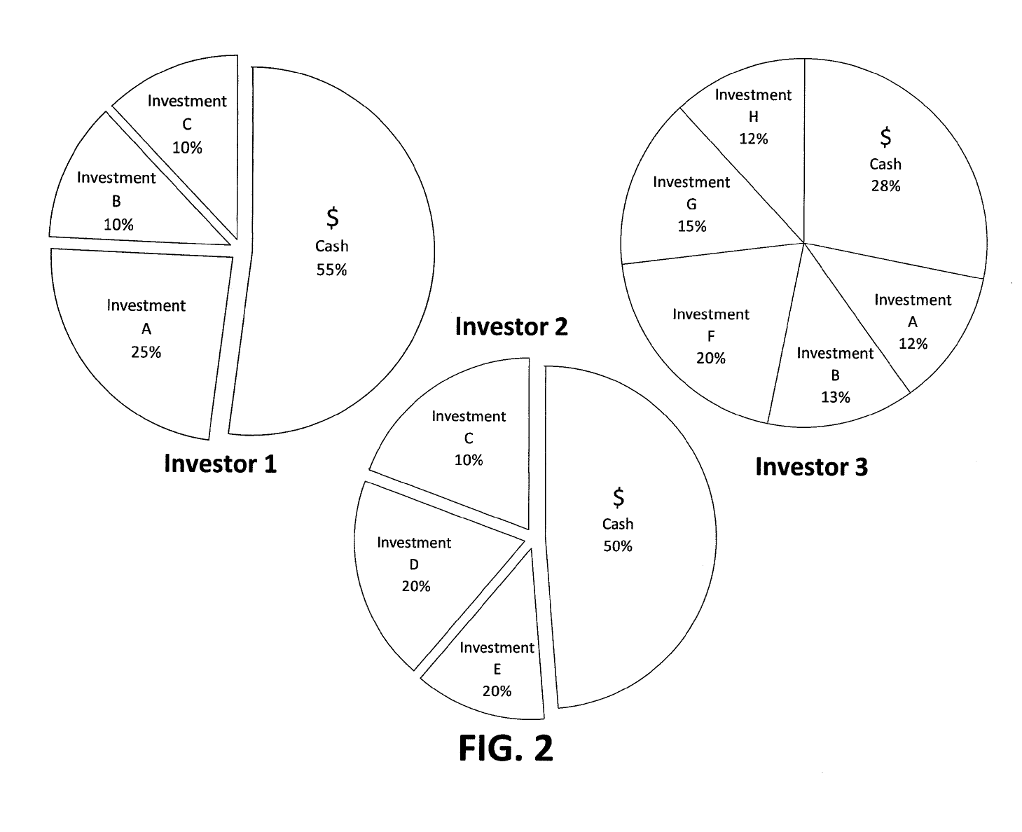

Certain investors may simply want to allocate their funds in a more traditional manner, by selecting specific investments. Referring now to FIG. 2, example allocations of three investors are depicted as pie charts. As shown in FIG. 2, Investor 1 may choose to invest 25% of the allotted funds in Investment A, 10% of the allotted funds in Investment B, and 10% of the allotted funds in Investment C and hold the remaining 55% as cash (e.g., a money market, savings account, etc.). Similarly, Investor 2 may choose to invest 10% of the allotted funds in Investment C, 20% of the allotted funds in Investment D, and 10% of the allotted funds in Investment E and hold the remaining 50% as cash. Lastly, Investor 3 may choose to invest 12% of the allotted funds in Investment A, 13% of the allotted funds in Investment B, 20% of the allotted funds in Investment F, 15% of the allotted funds in Investment G, and 12% of the allotted funds in Investment H and hold only 28% of the funds as cash.

These allocation percentages may be modified at the discretion of the investor. For example, when the investor retires or experiences other lifestyle changes, the investor may request a different allocation of assets based on different risk/return profiles. Allocations may also be modified based on general or particular economic forecasts (e.g., a bear market prediction may lead an investor to desire a larger allocation of assets in bonds or cash investments).

As time elapses and the investments fluctuate in value, the MDRPA software may track the performance of each investor's allocations (collectively, a portfolio). In certain embodiments, the MDRPA software may be further capable of generating raw data and/or visual demonstratives (e.g., charts or graphs) that may compare investors' performances and/or trends. The data and/or visual demonstratives may be made available (e.g., via the MDRPA website) for study and analysis by other MDRPA software participants in the system 100. The MDRPA software may also have the capability to export any gathered data to a third party that can manipulate and analyze the data (e.g., accountant, tax preparer, banker).

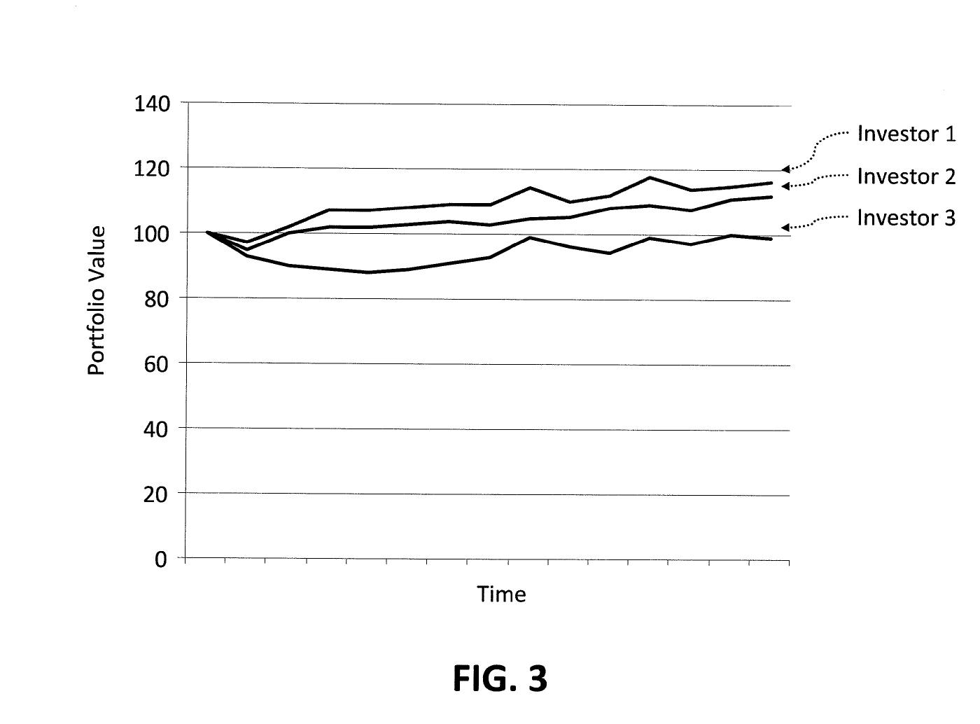

Turning now to FIG. 3, an exemplary performance graph of the three investors of FIG. 2 is depicted. The MDRPA software may be further customizable to allow a user to choose which investor portfolios are depicted and the data delivery format (e.g., charts, graphs, raw data, excel format, etc.). For simplicity's sake, only three investors are depicted in this example and it will be assumed that each investor started with a similar portfolio value (e.g., $100,000). As made evident by the graph, Investor 1 has the greatest return on the investment, followed by Investor 2, while Investor 3 has a negative return over the same time period. Using this data, another investor, such as Investor X, may be able to generalize that Investors 1 and 2 are better at choosing allocations because their portfolio values grew while that of Investor 3 declined in value.

In the event Investor X has limited experience in choosing investments, feels other investors are more experienced, and/or simply feels that the portfolios of Investors 1 and 2 will continue to succeed, Investor X may choose allocations based on another investor's allocations (e.g., by reviewing their performance data). Essentially, Investor X isn't choosing the specific investments, but rather, Investor X is choosing to dynamically mimic the portfolio allocations, or portions thereof, from certain other investors. Using software, Investor X may set up a custom portfolio by allocating one or more other investor's portfolios to create, or supplement, Investor X's own portfolio.

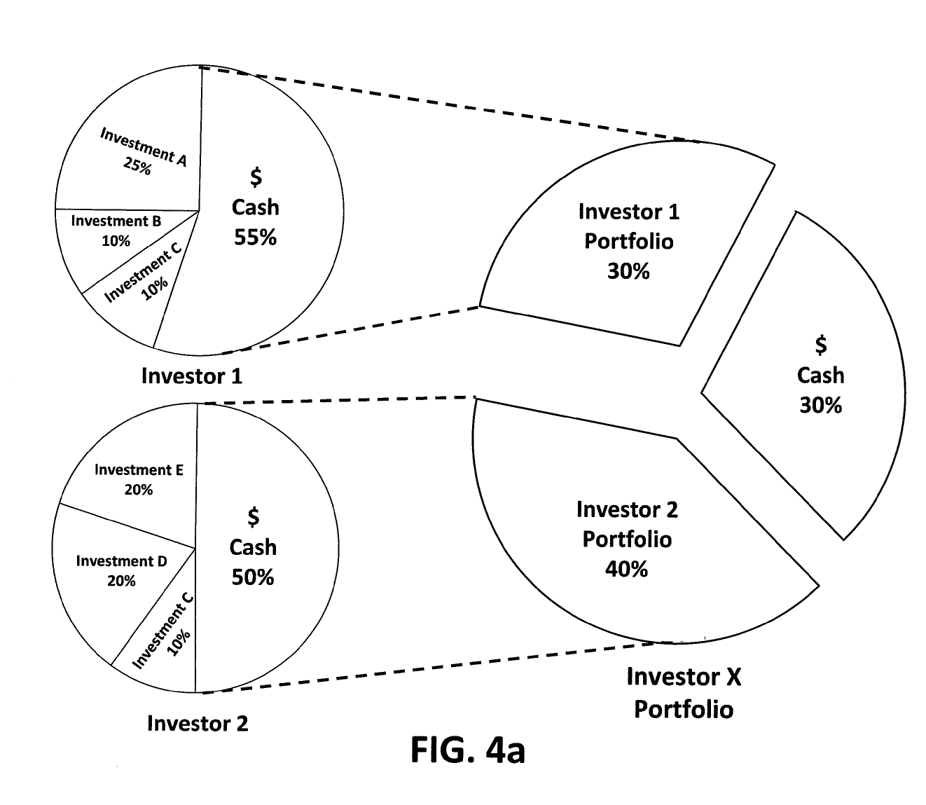

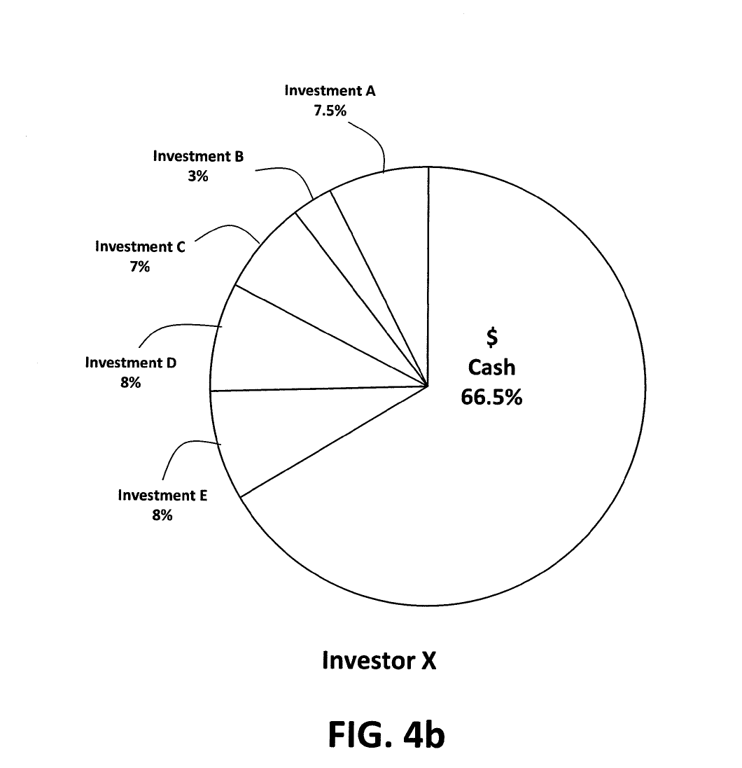

Building on the pervious example, FIG. 4a illustrates a situation in which Investor X has allocated 30% of Investors 1's allocations, 40% of Investor 2's allocations, and 30% of Investor X's own personal allocations to create a diversified portfolio. In this example, Investor X's allocation of 30% is cash; however, Investor X could have allocated investments, or a combination of investments and cash. This effectively means Investor X's portfolio is akin to a “fund-of-funds” by investing portfolio capital based on other investors' portfolios where each investor may be given a particular weight (in this example, 30% and 40%). To simplify the system and allow investors to easily select and invest in other investors, each investor may be provided a unique ticker symbol (e.g., akin to a stock symbol). For example, Investor 1 may be known and traded using the ticker symbol “SPAK,” Investor 2 may be known and traded using the ticker symbol “STAN” and Investor X may be known and traded using the ticker symbol “MSJT.” In this scenario, if an investor wishes to invest in the allocations of Investor 1 (which may be dynamically updated as Investor 1 edits the allocations), the investor need only specify that he or she would like to invest a certain percentage (e.g., a certain number of shares or dollars) in “SPAK.” For instance, an investor may opt to invest 50% of his or her portfolio in “SPAK,” 40% in “STAN” and 10% in “MSJT.”

In operation, a unique ticker symbol may be automatically generated and assigned to each investor upon account creation or when requested by the investor. In instances where a specific ticker symbol is requested by the investor, the system could first check a database of existing ticker symbols to ensure that the requested ticker symbol was not already in use. If the system determines that the ticker symbol is unique, the ticker symbol will be assigned. Otherwise, the system may prompt the investor to enter an alternative ticker symbol or will generate and assign a new symbol.

Referring now to FIG. 4b, when tracking and/or measuring Investor X's performance, the MDRPA software may track the performance as if Investor X had invested the following allocations:

TABLE 1

| Allocation | Percentage | Calculation |
|---|---|---|
| Investment A | 7.5% | 30% of Investor 1's 25% |
| Investment B | 3% | 30% of Investor 1's 10% |
| Investment C | 7% | 30% of Investor 1's 10% |
| | | 40% of Investor 2's 10% |
| Investment D | 8% | 40% of Investor 2's 20% |
| Investment E | 8% | 40% of Investor 2's 20% |
| Cash | 66.5% | 30% of Investor 1's 55% |
| | | 40% of Investor 2's 50% |
| | | Investor X's 30% |

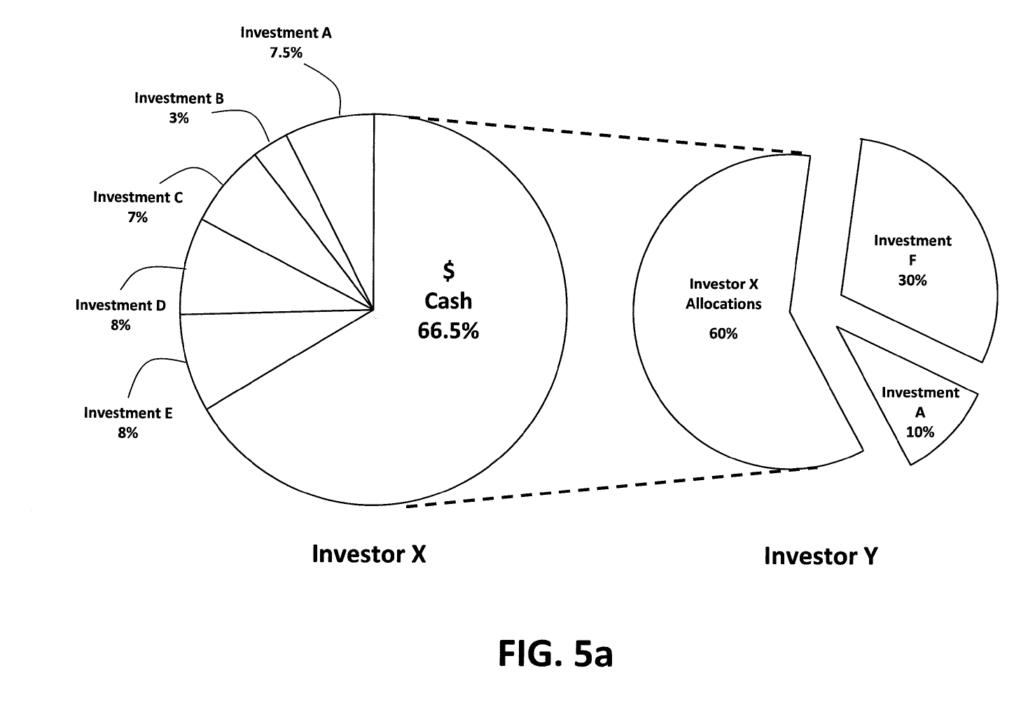

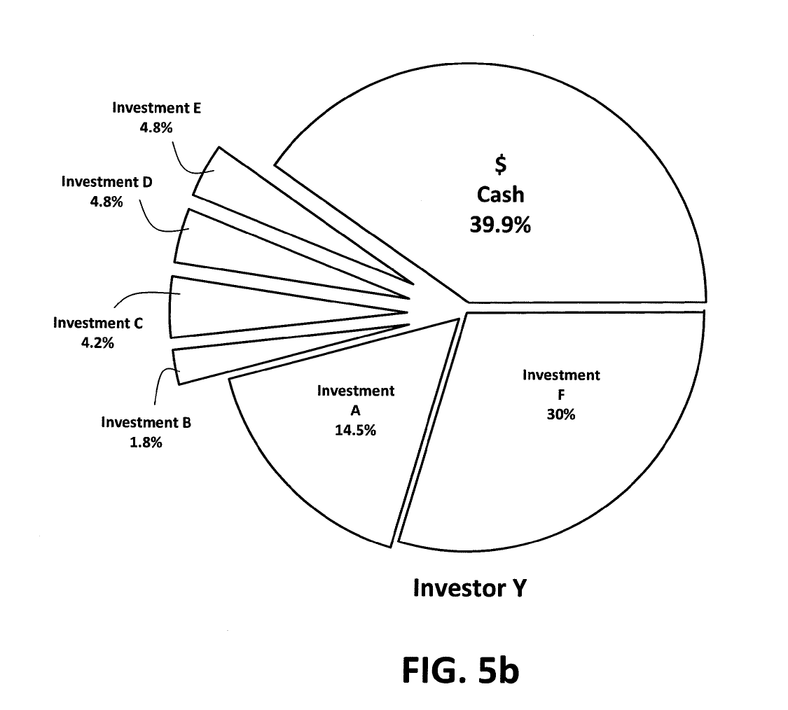

In the event that Investor X's portfolio is profitable and appears to be a lower-volatility strategy than following Investor 1 or Investor 2 alone, the Investor X portfolio performance may prompt yet another user, Investor Y, to allocate a portion of his/her portfolio to the allocations taught by Investor X. FIG. 5a illustrates a situation in which Investor Y has allocated 60% of Investor X's allocations and 40% of Investor Y's own personal allocations to create a further diversified portfolio.

Referring now to FIG. 5b, as in FIG. 4b, when tracking and/or measuring Investor Y's performance, the MDRPA software may track the performance as if Investor Y had invested the following allocations:

TABLE 2

| Allocation | Percentage | Calculation |
|---|---|---|
| Investment A | 14.5% | 60% of Investor X's 7.5% Investor Y's 10% |
| Investment B | 1.8% | 60% of Investor X's 3% |
| Investment C | 4.2% | 60% of Investor X's 7% |
| Investment D | 4.8% | 60% of Investor X's 8% |
| Investment E | 4.8% | 60% of Investor X's 8% |
| Investment F | 30% | Investor Y's 30% |
| Cash | 39.9% | 60% of Investor X's 66.5% |

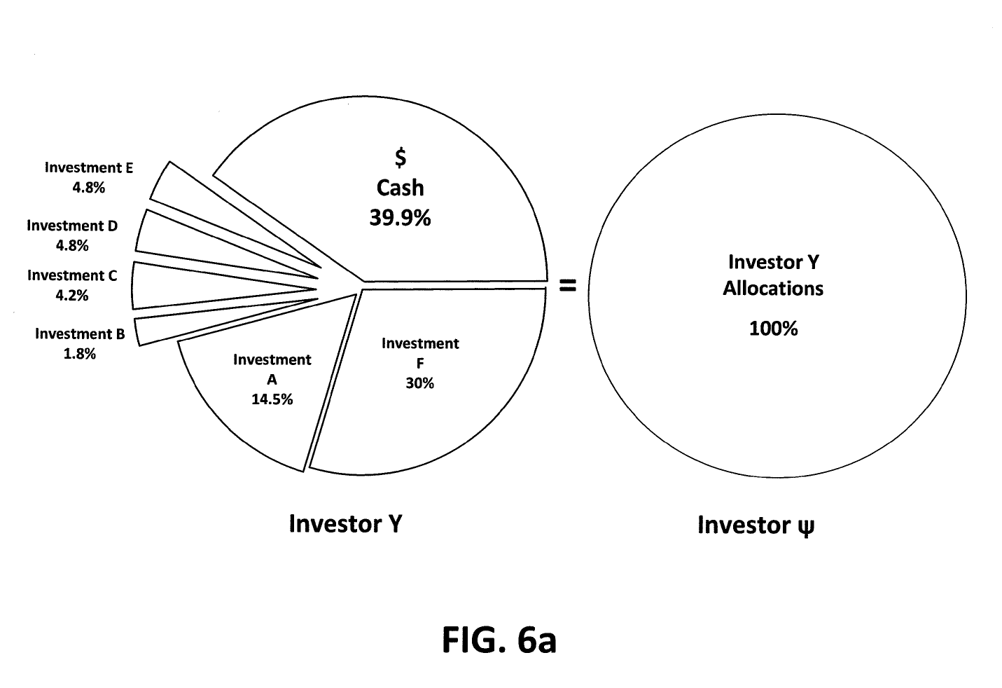

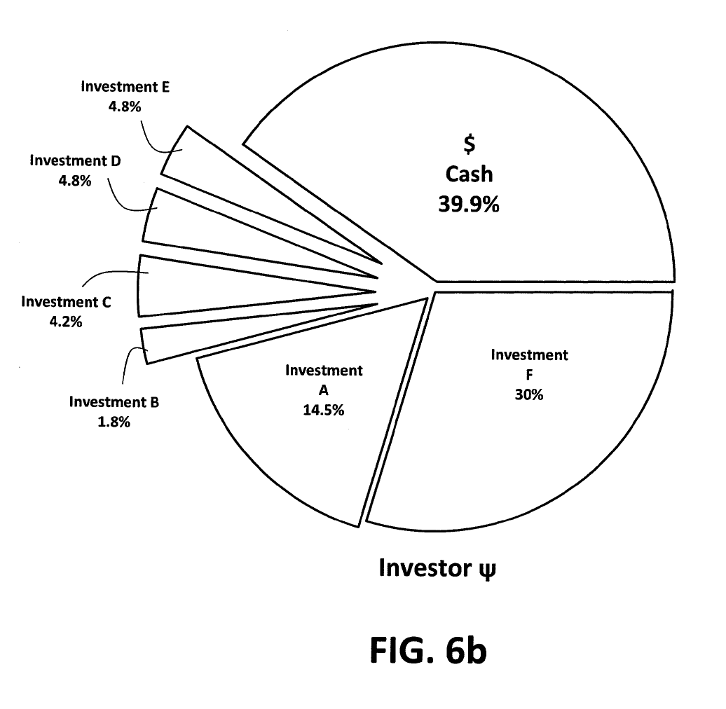

As shown in FIG. 6a, there is no requirement that investors diversify or have a minimum or maximum allocation amount. For example, if Investor Y's portfolio performance is even more successful than those of Investors 1, 2, and X, another investor, Investor ψ, may opt simply to allocate 100% of his/her portfolio as Investor Y (or another successful investor) has. In this situation, as reaffirmed in FIG. 6b, Investor ψ's portfolio would be identical to Investor Y's.

A system using MDRPA software enables anyone to be dependent and follow (rely on other people's portfolio allocations) and anyone to lead (choose his/her own allocations). This attribute may pave the way to a situation in which Investor Y's results are so remarkable, that an earlier investor (e.g., Investors 1, 2, 3, X, etc.) may decide to allocate some portion of his/her account the same way as the Investor Y allocations. As a result, all accounts following (directly or indirectly) the now-changed portfolio would also change. Essentially, a loop would be created where an investor's new allocations actually refer back to his own earlier allocations.

Unfortunately, Investor Y's portfolio may be successful because of its particular allocations, and changing a parent allocation (an allocation being followed and/or relied upon) could have a negative impact upon overall success of the dependent allocations (allocations which follow and/or rely upon a parent allocation). In this scenario, Investor Y's portfolio would be both a parent allocation and an indirect dependent allocation.

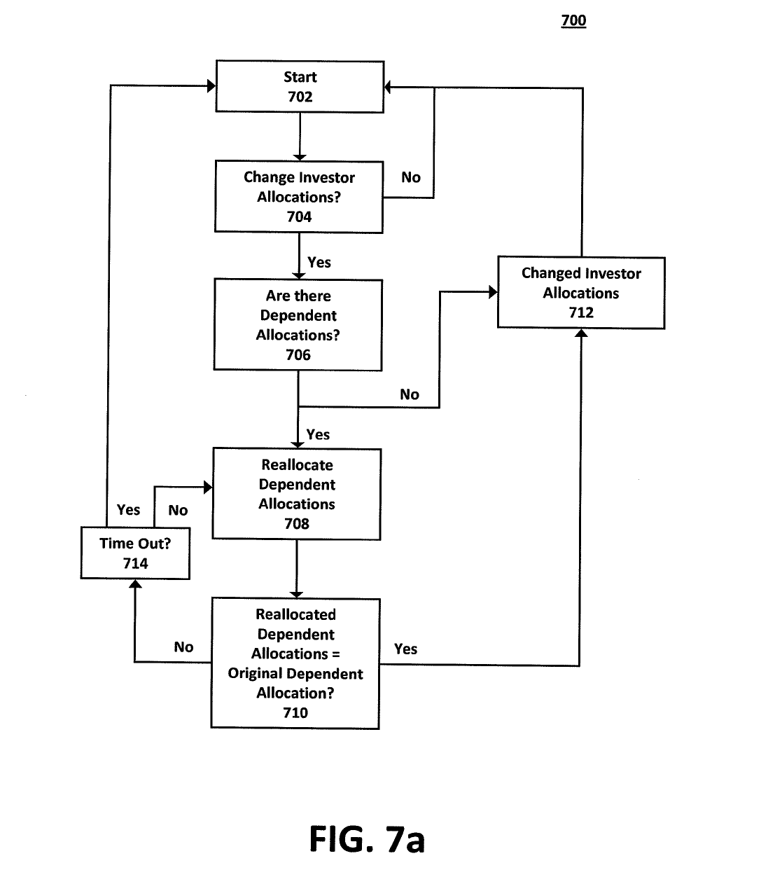

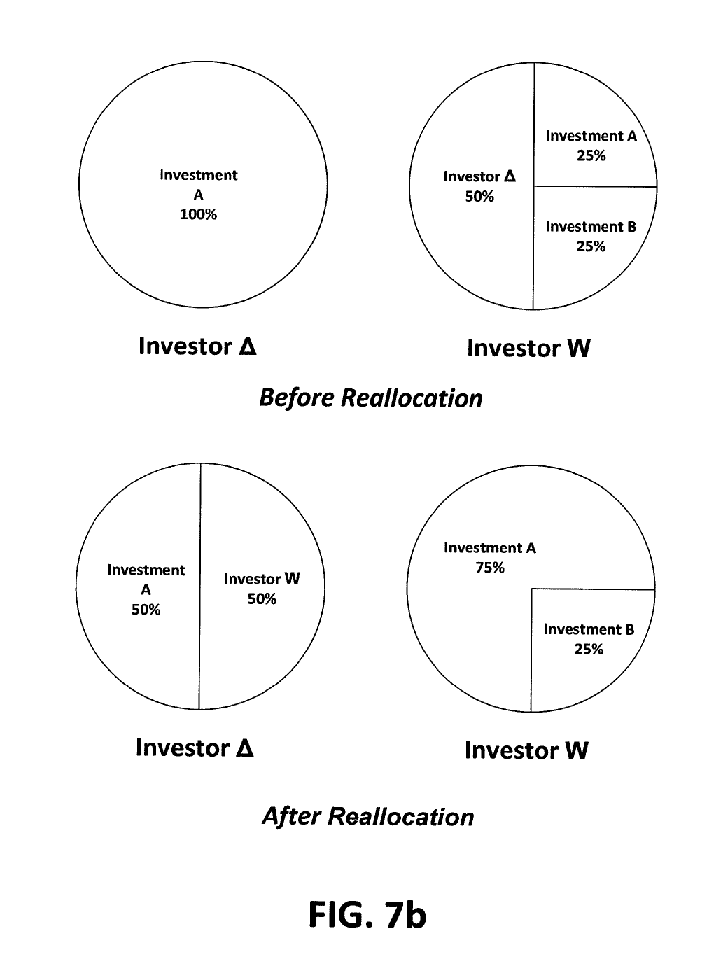

Referring to FIG. 7a, an example algorithm 700 is shown which may prevent the issue of indirectly linked dependent allocations changing a parent allocation when an investor such as Investor Y is following a chain of advisors, who ultimately follow Investor Y. This is prevented by recursively reallocating the portfolio, piece by piece, down the linked list of followers, until the delta quantity is so small as to be effectively zero. When an investor decides to change an allocation 704, the MDRPA software first determines if any other investor portfolios are dependent 706 upon the allocation being changed 704. A dependent portfolio is one following or relying upon the investor allocation that is being changed. If there are no dependent portfolios, the investor allocation is changed 712 as requested by the investor. However, if there are one or more dependent portfolios, the allocations in the one or more dependent portfolios that are impacted by the change 704 are reallocated such that the allocations are substantially equal to the allocations prior to the change 708.

For example, referring to 7b, in a situation where Investor Δ has 100% Investment A, and Investor W has 50% Investor A allocations, 25% Investment A, and 25% Investment B, it is clear that Investor W is a dependent portfolio of Investor A. If Investor A decides to change the allocations and allocate 50% to Investor W allocations and 50% to Investment A, Investor W's portfolios will be automatically reallocated such the 50% originally allocated to Investor A allocations is converted to 50% Investment A (the equivalent of Investor A's allocation before the change), such that Investor W's portfolio is composed of 75% Investment A (the original 25% Investment A+50% Investment of Investor A's allocation) and 25% Investment B. Therefore, Investor W's portfolio reallocation is equal to the allocations in place before Investor Δ made his change.

Referring back to FIG. 7a, once the MDRPA software has reallocated the Dependent Allocations 708, the MDRPA software checks to ensure that the new allocation investment distribution is substantially equal 710 to the distribution prior to the change. If the distributions are substantially equal 710, the investor allocation is changed 712 as requested by the investor 704. If the distributions are not substantially equal 710, the dependent portfolios are again reallocated until the allocations impacted by the change are equivalent to allocations prior to the change 708 or until a time-out 714 has been flagged. The time out 714 flag may be triggered by a particular number of failed attempts to reallocate (e.g., 5 failed attempts) or another error/cancellation signal (e.g., a trigger from the MDRPA software).

Although various embodiments have been described with reference to a particular arrangement of parts, features, and the like, these are not intended to exhaust all possible arrangements or features, and indeed many other embodiments, modifications, and variations will be ascertainable to those of skill in the art.

What is claimed is:

1. A process for sharing portfolio allocation information among various users, the process comprising the steps of:
(a) maintaining first portfolio allocation information concerning a plurality of first portfolio allocations in a database on a first server connected over a network to a plurality of user processors, wherein each first portfolio allocation is associated with a respective first user account;
(b) sending said first portfolio allocation information to a second user processor over said network in response to an inquiry from said second user processor, wherein said first portfolio allocation information includes performance information concerning each of said plurality of first portfolio allocations;
(c) receiving second portfolio allocation information concerning a second portfolio allocation from said second user processor over said network, wherein said second portfolio allocation information is based, at least in part, on said one or more first portfolio allocations; and
(d) incorporating said second portfolio allocation into said plurality of first portfolio allocations.

2. The process of claim 1, wherein said second portfolio allocation information is based on a fraction of an individual first portfolio allocation.

3. The process of claim 1, wherein said second portfolio allocation information is based on multiple fractions, at least two of said multiple fractions being associated, respectively, with corresponding first portfolio allocations selected from said plurality of first portfolio allocations.

4. The process of claim 1, wherein each portfolio allocation in the plurality of first portfolio allocations is hypothetical.

5. The process of claim 1, wherein said first portfolio allocation information is searchable.

6. The process of claim 1, wherein said second portfolio allocation is selectable from individual securities, or percentages thereof, and/or from said one or more first portfolio allocations, or percentages thereof.

7. The process of claim 1, wherein each of the plurality of first portfolio allocations is based on one or more individual securities, or percentages thereof, and/or from one or more other first portfolio allocations, or percentages thereof.

8. The process of claim 1, wherein each portfolio allocation is assigned a ticker symbol.

9. A process for selecting portfolio allocation information from a shared portfolio allocation database, the process comprising the steps of:
(a) sending an inquiry from a second user processor over a network to a first server for first portfolio allocation information concerning a plurality of first portfolio allocations, wherein said first server comprises said shared portfolio allocation database, and wherein each first portfolio allocation is associated with a respective first user account;
(b) receiving first portfolio allocation information at said second user processor over said network from said first server in response to said inquiry, wherein said first portfolio allocation information includes performance information concerning each of said plurality of first portfolio allocations;
(c) establishing second portfolio allocation information concerning a second portfolio allocation at said second processor, wherein said second portfolio allocation information is based, at least in part, on said one or more first portfolio allocations; and
(d) sending said second portfolio allocation information from said second user processor over said network to said first server for incorporation into said plurality of first portfolio allocations.

10. The process of claim 9, wherein said second portfolio allocation information is based on a fraction of an individual first portfolio allocation.

11. The process of claim 9, wherein said second portfolio allocation information is based on multiple fractions, at least two of said multiple fractions being associated, respectively, with corresponding first portfolio allocations selected from said plurality of first portfolio allocations.

12. The process of claim 9, wherein each portfolio allocation in the plurality of first portfolio allocations is hypothetical.

13. The process of claim 9, wherein said first portfolio allocation information is searchable.

14. The process of claim 9, wherein said second portfolio allocation is selectable from individual securities, or percentages thereof, and/or from said one or more first portfolio allocations, or percentages thereof.

15. The process of claim 9, wherein each of the plurality of first portfolio allocations is based on one or more individual securities, or percentages thereof, and/or from one or more other first portfolio allocations, or percentages thereof.

16. The process of claim 9, wherein each portfolio allocation is assigned a ticker symbol.

17. A computer system for sharing portfolio allocation information among various users, the computer system comprising:
a memory device having a database stored thereon;
a communication device operatively coupled to the memory device to receive input from a plurality of user processors over a network; and
at least one processor, operatively coupled to the communications device;
wherein the at least one processor maintains first portfolio allocation information concerning a plurality of first portfolio allocations in the database connected over said network to the plurality of user processors, wherein each first portfolio allocation is associated with a respective first user account;
wherein the at least one processor sends said first portfolio allocation information to a second user processor over said network in response to an inquiry from said second user processor, wherein said first portfolio allocation information includes performance information concerning each of said plurality of first portfolio allocations;
wherein the at least one processor receives second portfolio allocation information concerning a second portfolio allocation from said second user processor over said network, wherein said second portfolio allocation information is based, at least in part, on said one or more first portfolio allocations; and
wherein the at least one processor incorporates said second portfolio allocation into said plurality of first portfolio allocations.

18. The computer system of claim 17, wherein said second portfolio allocation information is based on a fraction of an individual first portfolio allocation.

19. The computer system of claim 17, wherein said second portfolio allocation information is based on multiple fractions, at least two of said multiple fractions being associated, respectively, with corresponding first portfolio allocations selected from said plurality of first portfolio allocations.

20. The computer system of claim 17, wherein each portfolio allocation in the plurality of first portfolio allocations is hypothetical.

21. The computer system of claim 17, wherein said first portfolio allocation information is searchable.

22. The computer system of claim 17, wherein said second portfolio allocation is selectable from individual securities, or percentages thereof, and/or from said one or more first portfolio allocations, or percentages thereof.

23. The computer system of claim 17, wherein each of the plurality of first portfolio allocations is based on one or more individual securities, or percentages thereof, and/or from one or more other first portfolio allocations, or percentages thereof.

24. The computer system of claim 17, wherein each portfolio allocation is assigned a ticker symbol.
